(19) United States
(12) Patent Application Publication
(10) Pub. No.: US 2015/0100785 A1
(43) Pub. Date: Apr. 9, 2015

(54) METHOD FOR CIPHERING A MESSAGE VIA A KEYED HOMOMORPHIC ENCRYPTION FUNCTION, CORRESPONDING ELECTRONIC DEVICE AND COMPUTER PROGRAM PRODUCT

(71) Applicant: THOMSON LICENSING, Issy de Moulineaux (FR)

(72) Inventors: Marc JOYE, Palo Alto, CA (US); Benoit LIBERT, Cesson-Sevigne (FR)

(21) Appl. No.: 14/508,337

(22) Filed: Oct. 7, 2014

(30) Foreign Application Priority Data
Oct. 9, 2013 (EP) 13306397.4

(51) Int. Cl. H04L 9/00; H04L 9/14

(52) U.S. Cl. CPC H04L 9/008; H04L 9/14; H04L 2209/24
USPC 713/168

(57) ABSTRACT

In one embodiment, it is proposed a method for ciphering a message by a sender device at destination to a receiver device, said method comprising using a keyed homomorphic encryption function associated with a public key of said receiver device. Such method is remarkable in that it comprises:
ciphering said message with an encryption scheme secure against adaptive chosen-ciphertext attacks, in function of a first element of said public key, delivering a ciphertext;
determining for said ciphertext, an homomorphic non-interactive proof and a simulation-sound non-interactive proof, said homomorphic non-interactive proof being obtained in function of a set of signatures comprised in said public key, and said simulation-sound non-interactive proof being obtained in function of a second element comprised in said public key, and an evaluation key of said keyed homomorphic encryption function being an element linked to said second element;
delivering a cipher of said message comprising said ciphertext, said homomorphic non-interactive proof and said simulation-sound non-interactive proof.

### TECHNICAL FIELD

The disclosure relates to cryptography, and more specifically to homomorphic encryption schemes.

### BACKGROUND

This section is intended to introduce the reader to various aspects of art, which may be related to various aspects of the present invention that are described andor claimed below. This discussion is believed to be helpful in providing the reader with background information to facilitate a better understanding of the various aspects of the present invention. Accordingly, it should be understood that these statements are to be read in this light, and not as admissions of prior art.

In homomorphic encryption schemes (either partially or fully encryption schemes), it is possible to publicly operate on a ciphertext and turn it into an encryption of a related message without knowing the decryption key. Such feature is called the malleability of homomorphic encryption scheme. Due to this malleability feature, the notion of security under adaptive chosen ciphertext attack (also named CCA2 security) and homomorphic encryption scheme were contradictory. Indeed, no one can obtain a homomorphic encryption scheme with a CCA2 security proof (see for example the following article: “On CCA-Secure Somewhat Homomorphic Encryption” by J. Loftus et al. in the conference SAC (“Selected Areas in Cryptography”) 2012, for more details on that issue). However, in the article “Chosen Ciphertext Secure Keyed-Homomorphic Public-Key Encryption” by Emura et al., published in the proceedings of the conference PKC 2013 (of which the full version is available on the Cryptology ePrint Archive (Report 2013390)), the authors proposed a technique that limit such malleability only to a user that owns a dedicated key (which is named an evaluation key), different from the decryption key in the homomorphic encryption scheme. Such “keyed” homomorphic encryption scheme can be proven CCA2 secure against any adversary who does not have the evaluation key). Also, another mandatory condition on such scheme is that the evaluation key does not enable decryption by itself. But, as acknowledged in the full version of the article of Emura et al., their constructions only satisfy a relaxed security definition wherein the adversary is not allowed to obtain homomorphic evaluations of the challenge ciphertext. However, there is no reason to impose this restriction as long as the resulting homomorphic evaluations are not queried for decryption. The present disclosure aims to overcome this issue. Moreover, it appears that many applications of homomorphic encryption schemes (like electronic voting or multiparty computation protocols) require a threshold decryption mechanism in any large-scale deployment: the decryption key must be shared among n servers in such a way that at least t out of these n servers have to contribute to each decryption operation. Unfortunately, the Emura et al. constructions disclosed in the previously mentioned article do not readily extend to the threshold setting because they do not provide ciphertexts of publicly verifiable validity. Indeed, in such scheme, deciding whether a ciphertext is valid or not requires knowledge of the decryption key. The aim of the present disclosure is to overcome this issue. Indeed, the present disclosure is a chosen-ciphertext-secure keyed-homomorphic cryptosystem with publicly verifiable ciphertexts. As a result, it is possible to set up a threshold decryption scheme that can be proven and remains chosen-ciphertext-secure under adaptive corruptions.

### SUMMARY

The present disclosure is directed to a method for ciphering a message by a sender device at destination to a receiver device, said method comprising a step of using a keyed homomorphic encryption function associated with a public key of said receiver device. Such step is remarkable in that it comprises:
a step of ciphering said message with an encryption scheme secure against adaptive chosen-ciphertext attacks, in function of a first element of said public key, delivering a ciphertext;
a step of determining for said ciphertext, an homomorphic non-interactive proof and a simulation-sound non-interactive proof, said homomorphic non-interactive proof being obtained in function of a set of signatures comprised in said public key, and said simulation-sound non-interactive proof being obtained in function of a second element comprised in said public key, and an evaluation key of said keyed homomorphic encryption function being an element linked to said second element;
a step of delivering a cipher of said message comprising said ciphertext, said homomorphic non-interactive proof and said simulation-sound non-interactive proof.

Hence, the ciphertext obtained tough the execution of such method is publicly verifiable. Such technique can be applied either in cloud services, or in data mining where keyed-homomorphic cryptosystem are needed. More usage scenarios where homomorphic cryptosystem (and therefore keyed-homomorphic cryptosystem) are described in the document entitled: “KV Web Security: Applications of Homomorphic Encryption” by Gerhard Potzelsberger.

In a preferred embodiment, such method for ciphering is remarkable in that said cipher of said message further comprises a one-time verification public key SVK and a one-time signature corresponding to a signature of a concatenation of said ciphertext, said homomorphic non-interactive proof and said simulation-sound non-interactive proof, said signature being verifiable with said verification public key SVK.

In a preferred embodiment, such method for ciphering is remarkable in that said encryption scheme is based on the Naor-Yung encryption paradigm.

In a preferred embodiment, such method for ciphering is remarkable in that said encryption scheme is based on the Cramer-Shoup paradigm.

In a preferred embodiment, such method for ciphering is remarkable in that said ciphertext corresponds to an uplet (C₀, C₁, C₂, C₃)=(M·X₁^{θ}^{₁}·X₂^{θ2}, f^{θ}^{₁}, h^{θ}^{₂}, g^{θ}^{₁}^{+θ}^{₂}) where M is said message and belongs to a group [symbol] encryption exponents θ₁, θ₂ that belong to group [symbol] ₚ are private random values, and elements X₁=f^{x}^{₁} g^{x}^{₀} ∈ [symbol] and X₂=h^{x}^{₂} g^{x}^{₀} ∈ [symbol] are comprised in said public key, with (x₀, x₁, x₂) ∈ [symbol] ₚ³ being unknown elements for said sender device and corresponding to a private key for said receiver device, and elements g, f h are elements that belong to said group [symbol] .

In a preferred embodiment, such method for ciphering is remarkable in that said step of determining said homomorphic non-interactive proof comprises:
a step of obtaining said set of signatures which is a signature on independent vectors \vec{f}=(f 1,g) ∈ [symbol] ³ and \vec{h}=(1, h, g) ∈ [symbol] ³ comprising elements {(aⱼ,b, cⱼ)}ⱼ₌₁² obtained through a use of a private key sk′={χᵢ, γᵢ, δᵢ}ᵢ₌₁ⁿ³, with (χᵢ, γᵢ, δᵢ) ∈ [symbol] ₚ³, and (a₁, b₁, c₁)=(f^{-χ}^{₁} g^{-χ}^{₃}, f^{-γ}^{₁} g^{-γ}^{₃}, f^{-δ}^{₁} g^{-δ}^{₃}), (a₂, b₂, c₂)=(h^{-χ}^{₂} g^{-χ}^{₃}, h^{-γ}^{₂} g^{-γ}^{₃}, h^{-δ}^{₂} g^{-δ}^{₃}), and public key associated to said private key sk′ being comprised in said public key of said receiver device;
a step of deriving a linearly homomorphic signature from said set of signatures and said encryption exponents θ₁, θ₂, delivering a derived signature (a, b, c)=(a₁^{θ}^{₁}·a₂^{θ2}, b=b₁^{θ1}·b₂^{θ2}, c=c₁^{θ}^{₁}·c₂^{θ}^{₂}) on vector (C₁, C₂, C₃), said derived signature being said homomorphic non-interactive proof.

In a preferred embodiment, such method for ciphering is remarkable in that said step of determining said simulation-sound non-interactive proof comprises:
a step of obtaining said second element corresponding to a one time homomorphic signature on the independent vectors \vec{f}=(f 1, g) ∈ [symbol] ³ and \vec{h}=(1, h, g) ∈ [symbol] ³ generated with a private key, said evaluation key corresponding to said private key;
a step of determining a derived signature on said second element, said derived signature being a one-time linearly homomorphic signature ;
a step of generating commitments on said derived signature using a Groth-Sahai common reference string based on said one-time verification public key VK;
a step of generating proofs with a randomizable linearly homomorphic structure-preserving signing method, said simulation-sound non-interactive proof being a concatenation of said commitments and said proofs.

In a preferred embodiment, such method for ciphering is remarkable in that said step of determining said simulation-sound non-interactive proof comprises a step of determining a non-interactive witness OR proof in function of said encryption exponents θ₁, θ₂ and said second element, said second element being a verification key of a digital signature method, and said evaluation key being a corresponding private key of said verification key of said digital signature method.

In a preferred embodiment, such method for ciphering is remarkable in that said digital signature method is a Waters signature method.

In another embodiment, it is proposed a method for processing a cipher of a message, said method being executed by a receiver device. Such method is remarkable in that it comprises:
a step of obtaining a homomorphic non-interactive proof and a simulation-sound non-interactive proof that are associated to said cipher;
a step of verifying a validity of said homomorphic non-interactive proof and said simulation-sound non-interactive proof, delivering an information of validity of said cipher.

In a preferred embodiment, such method for processing is remarkable in that said method further comprises a step of obtaining said message from said cipher in case that said information of validity asserts that said cipher is valid, by using a private key.

In a preferred embodiment, such method for processing is remarkable in that when at least a first and a second cipher of a first message and a second message are obtained by said receiver device, the method further comprises a set of combining said first and said second cipher by using an evaluation key, delivering a third cipher comprising an homomorphic non-interactive proof and a simulation-sound non-interactive proof.

According to an exemplary implementation, the different steps of the method are implemented by a computer software program or programs, this software program comprising software instructions designed to be executed by a data processor of an electronic device (or module or a computer device) according to the disclosure and being designed to control the execution of the different steps of this method.

Consequently, an aspect of the disclosure also concerns a program liable to be executed by a computer or by a data processor, this program comprising instructions to command the execution of the steps of a method as mentioned here above.

This program can use any programming language whatsoever and be in the form of a source code, object code or code that is intermediate between source code and object code, such as in a partially compiled form or in any other desirable form.

The disclosure also concerns an information medium readable by a data processor and comprising instructions of a program as mentioned here above.

The information medium can be any entity or device capable of storing the program. For example, the medium can comprise a storage means such as a ROM (which stands for “Read Only Memory”), for example a CD-ROM (which stands for “Compact Disc—Read Only Memory”) or a microelectronic circuit ROM or again a magnetic recording means, for example a floppy disk or a hard disk drive.

Furthermore, the information medium may be a transmissible carrier such as an electrical or optical signal that can be conveyed through an electrical or optical cable, by radio or by other means. The program can be especially downloaded into an Internet-type network.

Alternately, the information medium can be an integrated circuit into which the program is incorporated, the circuit being adapted to executing or being used in the execution of the method in question.

According to one embodiment, an embodiment of the disclosure is implemented by means of software andor hardware components. From this viewpoint, the term “module” can correspond in this document both to a software component and to a hardware component or to a set of hardware and software components.

A software component corresponds to one or more computer programs, one or more sub-programs of a program, or more generally to any element of a program or a software program capable of implementing a function or a set of functions according to what is described here below for the module concerned. One such software component is executed by a data processor of a physical entity (terminal, server, etc.) and is capable of accessing the hardware resources of this physical entity (memories, recording media, communications buses, inputoutput electronic boards, user interfaces, etc.).

Similarly, a hardware component corresponds to any element of a hardware unit capable of implementing a function or a set of functions according to what is described here below for the module concerned. It may be a programmable hardware component or a component with an integrated circuit for the execution of software, for example an integrated circuit, a smart card, a memory card, an electronic board for executing firmware etc.

In another embodiment, it is proposed a sender device (which is an electronic device) comprising means for ciphering a message, said means comprising means for using a keyed homomorphic encryption function associated with a public key of a receiver device. These means for using are remarkable in that they comprise:
means for ciphering said message with an encryption scheme secure against adaptive chosen-ciphertext attacks, in function of a first element of said public key, delivering a ciphertext;
means for determining for said ciphertext, an homomorphic non-interactive proof and a simulation-sound non-interactive proof, said homomorphic non-interactive proof being obtained in function of a set of signatures comprised in said public key, and said simulation-sound non-interactive proof being obtained in function of a second element comprised in said public key, and an evaluation key of said keyed homomorphic encryption function being an element linked to said second element;
means for delivering a cipher of said message comprising said ciphertext, said homomorphic non-interactive proof and said simulation-sound non-interactive proof.

In another embodiment, it is proposed a receiver device (which is an electronic device) comprising means for processing a cipher of a message. These means are remarkable in that they comprise:
means for obtaining a homomorphic non-interactive proof and a simulation-sound non-interactive proof that are associated to said cipher;
means for verifying a validity of said homomorphic non-interactive proof and said simulation-sound non-interactive proof, delivering an information of validity of said cipher.

### BRIEF DESCRIPTION OF DRAWINGS

The above and other aspects of the disclosure will become more apparent by the following detailed description of exemplary embodiments thereof with reference to the attached drawings in which:

FIG. 1 presents the main functions that define a keyed homomorphic encryption scheme with publicly verifiable ciphertexts, according to one embodiment of the invention;

FIG. 2 describes the main functions that define a (t; n) threshold keyed homomorphic encryption scheme, according to an embodiment of the invention;

FIG. 3 presents a device that can be used to perform one or several steps of methods disclosed in the present document.

### DESCRIPTION OF EMBODIMENTS

At a high level, we take a general approach that can be outlined as follows. We combine the Cramer-Shoup paradigm (described in the article “Universal Hash Proofs and a Paradigm for Adaptive Chosen Ciphertext Secure Public-Key Encryption”, by Ronald Cramer et al., and published in the proceedings of the conference Eurocrypt 2002) for constructing CCA2-secure encryption schemes with publicly verifiable simulation-sound proofs: simulation-soundness (see the article “Non-Malleable Non-Interactive Zero Knowledge and Adaptive Chosen-Ciphertext Security”, by Amit Sahai, published in the proceedings of the conference FOCS'99) refers to the inability of an adversary to convincingly prove a false statement, even after having observed a polynomial number of proofs for possibly false statements of its choice. Specifically, the construction below uses a variant of the Cramer-Shoup cryptosystem based on the Decision Linear assumption (as depicted in the article “Short Group Signatures”, by D. Boneh et al., published in the proceedings of the conference CRYPTO 2004), where ciphertexts are of the form (C₀, C₁, C₂, C₃)=(M·X₁^{θ}^{₁}·X₂^{θ}^{₂}, f^{θ}^{₁}, h^{θ}^{₂}, g^{θ}^{₁}^{+θ}^{₂}). This cryptosystem is combined with a technique suggested by Groth (in the article “Simulation-Sound NIZK Proofs for a Practical Language and Constant Size Group Signatures”, by J. Groth, published in the proceedings of the conference Asiacrypt'06) for constructing efficient simulation-sound non-interactive proofs allowing to convince a verifier that (C₁, C₂, C₃) are correctly formed.

In short, in order to prove a statement in a simulation-sound manner, Groth's technique consists in proving a disjunction of two statements: the prover generates a key pair (SVK,SSK) for a one time signature scheme before in proving that either the statement is true OR the prover knows a valid signature (generated w.r.t. to a public key pk_{w} included in the common reference string, for which no one knows the private key) on the one-time verification key SVK. The one-time private key SSK is then used to create a one-time signature on the overall proof. The construction hereunder uses Waters signatures (described in the article “Efficient Identity-Based Encryption Without Random Oracles”, by B. Waters, published in the proceedings of the conference Eurocrypt 20005) because its verification equation uses linear pairing product equations, which allows for a better efficiency when used in combination with non-interactive proof systems.

The key idea for building a keyed homomorphic cryptosystem from these techniques is to use the simulation-trapdoor of the simulation-sound proof system (which is the private key sk_{w}, associated with pk_{w}, in such scheme) as an evaluation key for the homomorphic cryptosystem. This will allow the homomorphic evaluation algorithm to simulate a convincing proof that its output ciphertext is correctly formed without knowing the underlying encryption exponents (which are used to generate a real non-interactive proof in the encryption algorithm). The novelty of the approach is thus to use the simulation trapdoor of the proof system in the real scheme, and not only in the security proof.

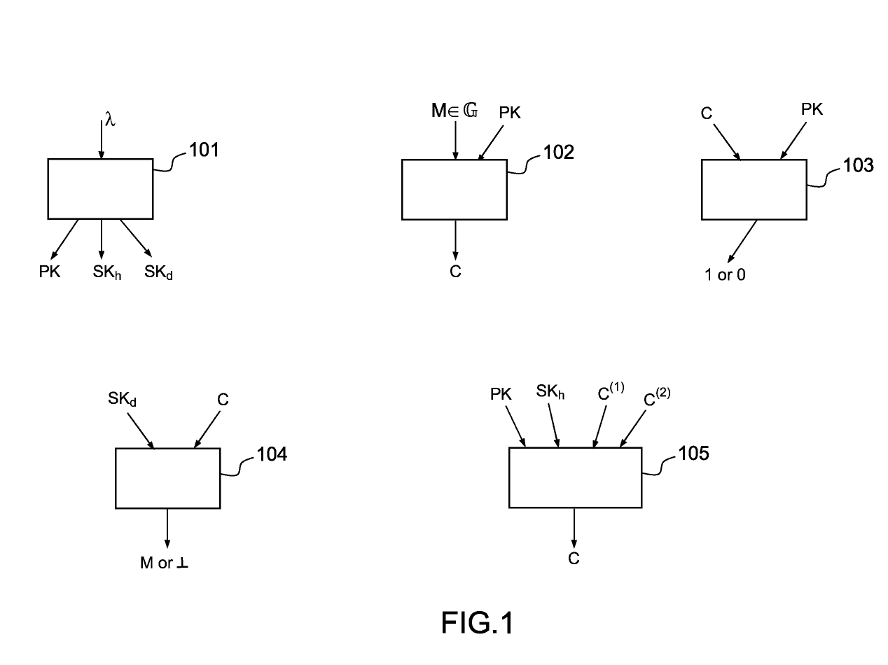

In order to make sure that the keyed homomorphic encryption scheme remains secure against non-adaptive chosen-ciphertext attacks (IND-CCA1) if the attacker obtains the evaluation key at the beginning of the attack, the ciphertext comprises a second non-interactive proof of ciphertext validity. In order to be processed by the homomorphic evaluation algorithm, this non-interactive proof must be homomorphic itself. One possibility would be to use Groth-Sahai proofs (see the article “Efficient Non-interactive Proof Systems for Bilinear Groups”, by J. Groth et al. published in the proceedings of the conferenceEurocrypt'08) which are known to be homomorphic. Here, we obtain a better efficiency by using homomorphic proofs derived from linearly homomorphic structure-preserving signatures as described in the article “Linearly Homomorphic Structure-Preserving Signatures and their Applications”, by B. Libert et al., published in the proceedings of the conference Crypto 2013). FIG. 1 presents the main functions that define a keyed homomorphic encryption scheme with publicly verifiable ciphertexts, according to one embodiment of the invention.

The function Keygen(λ), referenced 101, takes as input a security parameter A, and outputs a public key, a private key and an evaluation key. Such function 101 comprises:
a step of obtaining a bilinear groups ( [symbol] , [symbol] _{T}) of prime order p>2^{λ} and obtaining the followings elements g, f,h [symbol] [symbol] x₀, x₁, x₂ [symbol] [symbol] ₚ (where the notation s [symbol] S means that the element s is picked uniformly at random from a set S, and the notation x,y,z [symbol] S means that the elements x, y, z are picked independently and uniformly at random from the set S) and determining X₁=f^{x}^{₁}g^{x}^{₀} ∈ [symbol] , X₂=h^{x}^{₂} g^{x}^{₀} ∈ [symbol] , which form a Cramer-Shoup public key;
a step of initiating the vectors \vec{f}=(f, 1,g) ∈ [symbol] ³ and \vec{h}=(1, h, g) ∈ [symbol] ³;
a step of obtaining the elements f₁, f₂ [symbol] [symbol] and initiating the vectors

$${\vec{f}}_{1} = ( {f}_{1} , 1 , g ) , {\vec{f}}_{2} = ( 1 , {f}_{2} , g ) , {\vec{f}}_{3} = {\vec{f}}_{1}^{{φ}_{1}} \cdot {\vec{f}}_{2}^{{φ}_{2}} \cdot {( 1 , 1 , g )}^{- 1}$$

where Φ₁, Φ₂ [symbol] [symbol] ₚ which will be used as a perfectly hiding Groth-Sahai CRS (for “Common Reference String”) for the generation of NIWI (for “Non-Interactive Witness Indistinguishable”) arguments;
a step of obtaining a strongly unforgeable one-time signature Σ=( [symbol] ,S,υ) with verification keys consisting of L-bit strings, for some polynomially bounded L, and [symbol] corresponds to a key generation algorithm, S corresponds to a signature algorithm and

υ corresponds to a verification algorithm;
a step of generating a key pair for the one-time linearly homomorphic structure preserving signature scheme (suggested in “Linearly Homomorphic Structure-Preserving Signatures and their Applications”, by B. Libert et al., and published in the proceedings of the conference Crypto 2013) for vectors of dimension n=3. Let pkₒₜ=(g_{z}, gᵣ, h_{z}, hᵤ, {gᵢ hᵢ}ᵢ₌₁³) be the public key, and let skₒₜ=({χᵢ, γᵢ, δᵢ}ᵢ₌₁³) be the corresponding private key;
a step of signing the independent vectors \vec{f}=(f,1, g) ∈ [symbol] ³ and \vec{h}=(1, h, g) ∈ [symbol] ³ via the use of the private key skₒₜ, that delivers a one-time linearly homomorphic signature {(zⱼ, rⱼ, uⱼ)}ⱼ₌₁² defined as follows:

(z₁, r¹, u₁)=(f^{-χ}^{₁}g^{-χ}^{₃}, f^{-γ}^{₁}g^{-γ}^{₃}, f^{-δ}^{₁}g^{-δ}^{₃}),

(z₂, r₂, u₂)=(h^{-χ}^{₂}g^{-χ}^{₃}, h^{-γ}^{₂}g^{-γ}^{₃}, h^{-δ}^{₂}g−δ^{₃});
a step of generating a private key sk_{w}=Y^{x} and the corresponding public key pk_{w}=(X=g^{x}, Y, w=(w₀, . . . , w_{L})) compliant with the Waters signature scheme. For any string τ=τ[1] . . . τ[L] ∈ {0,1}^{L}, we denote by H_{G}(τ)=w₀·Πᵢ₌₁^{L}wᵢ^{τ[i]} the corresponding hash value; As mentioned previously, another signature scheme can be used instead of the Waters signature scheme. However, for efficiency issues, the Waters signature scheme should be used due to the fact that: (i) Its security is proved under the Diffie-Hellman assumption which is already implied by the Decision Linear assumption (so, it does not introduce any extra assumption); (ii) Its verification equation is a linear pairing product equation, which gives a shorter OR proof in the final ciphertext;
a step of outputting a public key which is defined as follows:

PK=(g,\vec{f},\vec{h},\vec{f}₁,\vec{f}₂,\vec{f}₃,X₁,X₂, pkₒₜpk_{w},{(zⱼ, rⱼ, uⱼ)}ⱼ₌₁²)
a step of outputting an evaluation key SKₕ=sk_{w}=Y^{x}, and a decryption key

SK_{d}=(x₀, x₁, x₂).

The function Encrypt(M, PK), referenced 102, takes as input a message M E G and the public key PK (corresponding to the output of the function 101). It outputs a ciphertext that is publicly verifiable.

In order to encrypt a message M ∈ [symbol] the function 102 comprises the following steps that must be executed by a device:
a step of generating a one-time signature key pair (SVK,SSK)← [symbol] (λ);
a step of choosing elements θ₁, θ₂ [symbol] [symbol] ₚ;
step of determining the following elements based on the elements θ₁, θ₂ and elements comprised in the public key PK:

C₀=M·X₁^{θ}^{₁}·X₂^{θ}^{₂}, C₁=f^{θ}^{₁}, C₂=h^{θ2}, C₃=g^{θ}^{₁}^{+θ}^{₂};
step of determining a derived one time linearly homomorphic signature (z, r, u) on the vectors (C₁, C₂, C₃) ∈ [symbol] ³. More precisely, such step does not explicitly use the vectors (C₁, C₂, C₃) ∈ [symbol] ³, but uses the elements θ₁, θ₂ ∈ [symbol] ₚ, as encryption exponents in the following equations:

z=z₁^{θ}^{₁}·z₂^{θ}^{₂}; r=r₁^{θ}^{₁}·r₂^{θ}^{₂}; u=u₁^{θ}^{₁}·u₂^{θ}^{₂};
a step of choosing σ₀, σ₁ [symbol] [symbol] at random
a step of generating perfectly hiding commitments using the vectors \vec{f′}=(\vec{f}₁, \vec{f}₂, \vec{f}₃), as a Groth Sahai CRS, such step comprising the generation of commitments \vec{C}_{σ}_{₀}, \vec{C}_{Θ}_{₁}, \vec{C}_{Θ}_{₂} to elements σ₀, Θ₁=g^{θ}^{₁} and Θ₂=g^{θ}^{₂}, respectively; p1 a step of determining a NIWI argument π_{OR} that either the following equalities are satisfied

e(C₁,y)=e(f,Θ₁)

e(C₂,g)=e(h,Θ₂) (*)

e(C₃,g)=e(g,Θ₁·Θ₂)

or (σ₀,σ₁) is a valid Waters signature on the one-time verification key SVK, i.e. the following equality stands:

e(σ₀,g^{1-γ})=e(X,Y^{1-γ}.e(H_{G}(SVK)^{1-γ},σ₁);

In the real encryption method, the pair (σ₀, σ₁) does not satisfy the above equality (since it is chosen at random) but the proof of the statement (*) is a real proof. In the homomorphic evaluation algorithm, a simulated proof for a potentially false statement (*) will be obtained by using an actual Waters signature (σ₀, σ₁) as a witness for generating the OR proof π_{OR}.

To generate π_{OR}, such step of generating a NIWI argument comprises the following actions: define γ=1 and generate commitments \vec{C}_{Γ}_{_{g}}\vec{,C}₆₄ _{_{f}}, \vec{C}_{Γ}_{ₕ}, \vec{C}_{Γ}_{Y}, \vec{C}_{Γ}_{_{H}} to the variables Γ_{g}=g^{γ}, Γ_{f}=f^{γ}, Γₕ=h^{γ}, Γ_{Y}=Y^{γ}and Γ_{H}= [symbol] (SVK)^{γ} and non interactive proof (π₁, . . . , π₉) for the relations, referenced eq1 to eq 9 respectively):

e(Γ_{g},Γ_{g})=e(Γ_{g},g)

e(Γ_{g},f)=e(g,Γ_{f})

e(Γ_{g},h)=e(g,Γₕ)

e(Γ_{g},Y)=e(g,Γ_{Y})

e(Γ_{g}, [symbol] (SVK))=e(g,Γ_{H})

e(C₁,Γ_{g})=e(Γ_{f},Θ₁)

e(C₂,Γ_{g})=e(Γₕ,Θ₂)

e(C₃.Θ₁⁻¹.Θ₂⁻¹,Γ_{g})=1_{G}_{_{T}}

e(σ₀,g/Γ_{g})=e(X,Y/Γ_{Y}).e( [symbol] (SVK)/Γ_{H},σ₁))

The equation eq1 and eq6 to eq9 are quadratic, so that proofs π₁, π₆, π₇,π₈, π₉ require 9 group elements each. Equations eq2 to eq5 are linear, so that π₂, π₃, π₄ and π₅ require 12 group elements altogether. The whole proof π_{OR} consists of (\vec{C}_{Γ}_{_{g}}\vec{, C}_{Γ}_{_{f}}, \vec{C}_{Γ}_{ₕ}, \vec{C}Γ_{Y}, \vec{C}_{Γ}_{_{H}}, (π₁, . . . . , π₉)) and thus costs 72 group elements;
a step of generate a one-time signature with the one-time signature private key SSK previously generated:

sig=S(SSK,(C₀,C₁,C₂,C₃,z,r,u, σ₁,\vec{C}_{σ}_{₀},\vec{C}_{Θ}_{₁},\vec{C}_{Θ}_{₂}, π_{OR}));
a step of outputting the ciphertext:

C=(SVK,C₀, C₁, C₂, C₃,z,r,u, σ₁,\vec{C}_{σ}_{₀},\vec{C}Θ_{₁},\vec{C}Θ_{₂},π_{OR},sig).

The function Ciphertext-Verify(PK,C), referenced 103, is a function that determines from a ciphertext with the same form as the one outputted by the function 102, and the public key PK if a received ciphertext has been generated correctly with function 102 and the given public key PK. Such function returns 1 if and only if sig is a valid one time signature with regards to the verification key SVK and if the element π_{OR} is a valid proof. In that case, it means that the ciphertext has been obtained through the use of the function 102 and the given public key PK. Otherwise (if the function 103 outputs 0), it means that the ciphertext has not been obtained through the use of the function 102 and the given public key PK.

The function Decrypt(PK, SK_{d}, C), referenced 104, takes on input the private key SK_{d}=(x₀, x₁, x₂), the ciphertext C and a public key PK. It outputs the message that was encrypted with the function 102. Such function 104 comprises an execution of the function 103. Indeed, the function 1104 returns ⊥ in the event that Ciphertext-Verify(PK,C)=0. Otherwise, the function 104 performs a step of determining the following element C₀.C₁^{-x}^{₁}.C₂^{-x}^{₂}C₃^{-x}^{₀} from elements comprised in the ciphertext C and the private key SK_{d}. The element C₀.C₁^{-x}^{₁}.C₂^{-x}^{₂}C₃^{-x}^{₀} corresponds to the message M.

The function Eval(PK, SKₕ, C⁽¹⁾, C⁽²⁾), referenced 105, enables to determine a ciphertext from two ciphertexts C⁽¹⁾ and C⁽²⁾, the public key PK and an evaluation key SKₕ. For reminders, the evaluation key is defined as follows : SKₕ=sk_{w}=Y^{x}. The function 105 comprises a step of parsing the ciphertexts C^{(j)} (for each j ∈ {1,2}) as follows:

C^{(j)}=(SVK^{j},C₀^{(j)},C₁^{(j)},C₂^{(j)},C₃^{(j),z}^{(j)},r^{(j)},u^{(j)},σ₁^{(j)},\vec{C}_{σ}_{₀}^{(j)},\vec{C}_{Θ}_{₁}^{(j)},\vec{C}_{Θ}_{₂}^{(j)}π_{OR}^{(j)},sig^{(j)})

Moreover, the function 105 comprises:
a step of determining the elements C₀=Πⱼ₌₁² C₀^{(j)}, C₁=Πⱼ₌₁² ₁^{(j)}, C₂=Πⱼ₌₁² C₂^{(j)} and C₃=Πⱼ₌₁² C₃^{(j)} as well as z=Πⱼ₌₁² z^{(j)}, r4=Πⱼ₌₁² r^{(j)} and u=Π^{j=1}² u^{(j);}
a step of generating a new one-time signature key pair (SVK,SSK)← [symbol] (λ);
a step of using the private evaluation key SKₕ=sk_{w}=Y^{x} in order to generate a valid Waters signature (σ₀, σ₁);
a step of using such Waters signature (σ₀,σ₁) as a witness to generate a NIWI OR proof π_{OR} that either e(C₁, g)=e(f, Θ₁); e(C₂,g)=e(h, Θ₂); e(C₃,g)=e(g, Θ₁.Θ₂); or (σ₀,σ₁) is a valid Waters signature on SKV, i.e., e(σ₀, g)=e(X,Y).e( [symbol] (SVK),σ₁)); said proof having the following form π_{OR}=(\vec{C}_{Γ}_{_{g}},\vec{C}_{Γ}_{_{f}},\vec{C}_{Γ}_{ₕ},\vec{C}_{Γ}_{_{Y}},\vec{C}_{Γ}_{_{H}}, (π₁, . . . , π₉)) and comprising 72 group elements;
a step of generating a one time signature

sig=S(SSK,(C₀, C₁, C₂, C₃, z,r,u,σ₁,\vec{C}_{σ}_{₀},\vec{C}_{Θ}_{₁},\vec{C}_{Θ}_{₂},π_{OR}));
a step of outputting the following ciphertext C=(SVK, C₀, C₁, C₂, C₃, z,r,u,σ₁, \vec{C}_{σ}_{₀}, \vec{C}_{Θ}_{₁}, \vec{C}_{Θ}_{₂}, π_{OR}, sig).

If the scheme is instantiated using Groth's one-time signature, the whole ciphertext requires 94 group elements. At the 128-bit security level, each ciphertext fits within 5.8 kB.

Such scheme defined that the use of functions 101, 102, 103, 104 and 105 is a keyed homomorphic public key encryption scheme that is secure against chosen-ciphertext attacks (also named KH-CCA secure) and for which ciphertexts are publicly verifiable (that therefore enables to easily define a threshold keyed homomorphic public key encryption scheme). Indeed, with such scheme, no PPT (for “Probabilistic Polynomial Time”) adversary (i.e. a computationally bounded adversary) has a non-negligible advantage in this game:
1. The challenger runs the function 101 to obtain a public key PK, a decryption key SK_{d} and a , homomorphic evaluation key SKₕ. He gives the public PK to an adversary A and keeps private both the evaluation key SKₕ and the decyption key SK_{d} to itself. In addition, the challenge initializes a set D as an empty set;
2. The adversary A adaptively makes queries to the following oracles:
Evaluation query: at any time, the adversary A can invoke the evaluation oracle Eval(PK,SKₕ,.) (i.e. the function 105) on a pair (C(¹), C(²)) of ciphertexts of its choice. If there exists j ∈ {1,2} such that Ciphertext-Verify(PK, C^{(j )})=0, the algorithm returns ⊥. Otherwise, the oracle Eval(PK,SKₕ,.) delivers a ciphertext C←Eval(SKₕ, C⁽¹⁾, C⁽²⁾). In addition, if C⁽¹⁾ ∈ D or C⁽²⁾ ∈ D, he sets D←D ∪ {C};
Reveal query: at any time, the adversary A may also decide to corrupt the evaluator by invoking a RevHK oracle on a unique occasion. The oracle responds by returning the evaluation key SKₕ, which is no more a secret parameter for the adversary;
Decryption query: the adversary A can also invoke the decryption oracle on arbitrary ciphertexts C of his choice. If Ciphertext-Verify(PK, C)=0, or if C ∈ D, the oracle returns ⊥. Otherwise, the oracle returns the output of the function Decrypt(PK, SK_{d}, C);

3. The adversary A chooses two equal-length messages M₀, M₁ and obtains a ciphertext C*=Encrypt(PK, M_{β}) (i.e. the result of the function 102) for some random bit β [symbol] {0,1}. In addition, the challenger sets D←D ∪ {C*};

4. Then, the adversary A makes further queries as in step 2 with one additional restriction.

Namely, if the adversary A chooses to obtain the evaluation key SKₕ (via a reveal query) at some point, no more decryption query is allowed beyond that point.

5. The adversary A outputs a bit β′ and is deemed successful if β′=β. As usual, the adversary A's advantage is measured as the distance

$$Adv ( A ) = \vert Pr ( {β}^{′} = β ) - \frac{1}{2} \vert .$$

The keyed homomorphic encryption scheme with publicly verifiable ciphertexts described previously relies on the use of non-interactive OR proofs as in a similar CCA-secure cryptosystem suggested by Groth in (“Simulation-Sound NIZK Proofs for a Practical Language and Constant Size Group Signatures”, by Jens Groth, Asiacrypt'06, pp. 444-459). Specifically, the device that uses the function 102 generates a non-interactive proof that either: (i) the ciphertext is well-formed (namely, that the elements (C₁, C₂, C₃) live in a two-dimensional subspace); (ii) or it knows a valid digital signature (for a signature scheme whose public key is part of the receiver's public key) on the one-time verification key SVK or which a one-time signature is generated on the entire ciphertext. In this case, the homomorphic evaluation key SKₕ consists of the private key of the digital signature whose verification key is included in the receiver's public key. For efficiency reasons, the previous scheme was instantiated by using Waters signatures as it makes it possible to work with linear pairing product equations in order to have shorter Groth-Sahai NIWI proofs. Other signature schemes than Waters' could be used for this purpose, but they are likely to incur quadratic pairing-product equations during the verification of OR proofs. When running the homomorphic evaluation algorithm, the evaluator is able to generate a non-interactive proof by generating the OR proof using a valid Waters signature (σ₀, σ₁) as a witness. In contrast, the sender is not able to compute Waters signatures (as he does not have the private key) and always generates the OR proof using the witness (θ₁, θ₂) showing that the ciphertext is well-formed. Consequently, the sender is unable to generate a proof for an invalid ciphertext unless he is able to forge valid Waters signatures. To generate OR proofs, we use a technique which consists in introducing extra binary exponents γ ∈ {0,1}.The NIWI property of these OR proofs guarantees that no one will be able to distinguish proofs generated using the encryption exponents (θ₁, θ₂) as witnesses from proofs generated by the evaluator using a Waters signature (σ₀, σ₁).

The drawback of the previous solution is that it requires relatively large ciphertexts, each of which costs about 90 group elements. To reduce this overhead, another embodiment hereunder builds on the same design principle (notably in that the homomorphic evaluation key consists of the simulation-trapdoor of a simulation-sound non-interactive proof system) but uses a different simulation-sound proof system which is tailored to proving membership in a linear subspaces is depicted. The advantage of this proof system is that it does not require OR proofs and thus provides much shorter non-interactive proofs. Each non-interactive simulation-sound proof consists of a linearly homomorphic structure preserving signature (based on a scheme suggested in the article “Linearly Homomorphic Structure-Preserving Signatures and their Applications”, by B. Libert et al., published in the proceedings of the conference Crypto 2013) and can be seen as a Groth-Sahai-based proof of knowledge of a one-time linearly homomorphic signature.

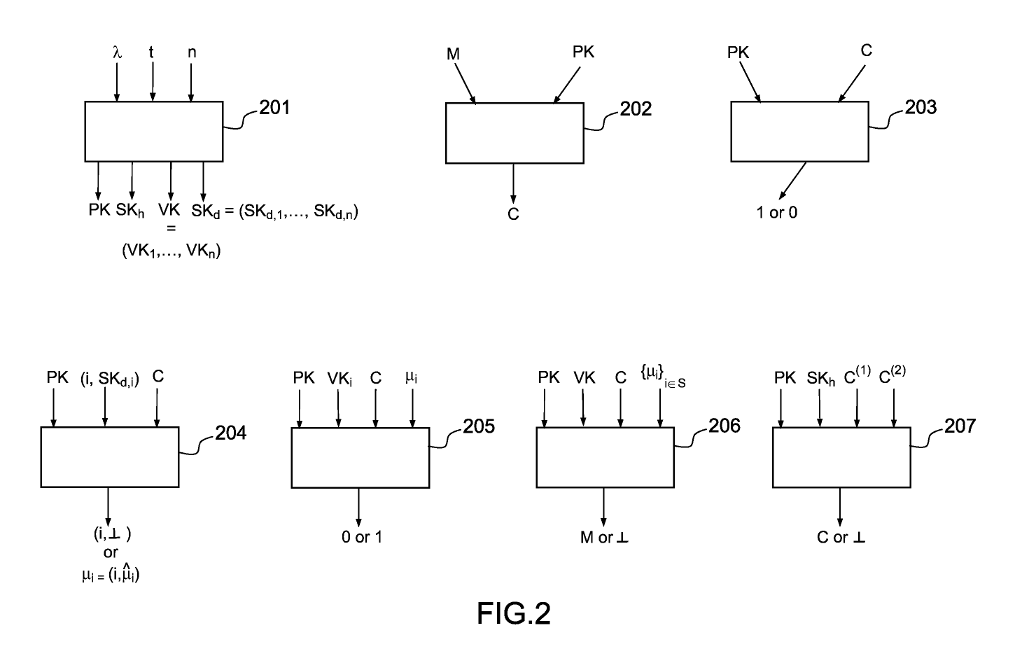

FIG. 2 describes the main functions that define a (t; n) threshold keyed homomorphic encryption scheme, according to an embodiment of the invention.

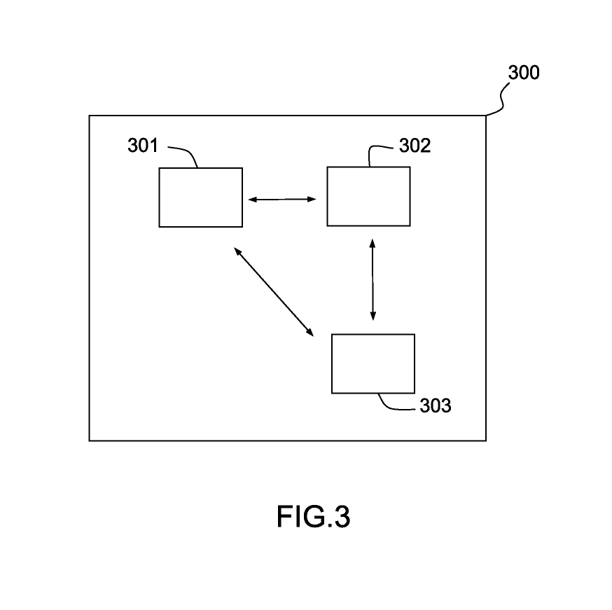

The function Keygen(λ, t, n), referenced 201, takes as input a security parameter λand integers t,n ∈ poly(λ) (with 1≦t≦n), where n is the number of decryption servers and t is the decryption threshold (let's remark that when t=n=1, the definition of a threshold keyed homomorphic public key encryption scheme corresponds to the one of a keyed homomorphic public key encryption scheme). It outputs elements (PK, SKₕ, VK, SK_{d}), where PK is the public key, SKₕ is the homomorphic evaluation key, SK_{d}=(SK_{d,1}, . . . , SK_{d,n}) is a vector of private key shares and VK=(VK₁, . . . , VKₙ) is a vector of verification keys. For each i, the decryption server i is given the share (i, SK_{d,i}). The verification key VKᵢ will be used to check the validity of decryption shares generated using SK_{d,i}. In one embodiment, such function 201 comprises:
a step of obtaining:
   bilinear groups ( [symbol] , [symbol] , [symbol] _{T}) of prime order p>2^{λ}, with an efficient isomorphism Ψ: [symbol] → [symbol] ;
   generators f, h [symbol] [symbol] , ĝ [symbol] [symbol] ;
   elements x₀, x₁, x₂ [symbol] [symbol] ₚ;
   elements X₁=f^{x}^{₁} g^{x}^{₀} ∈ [symbol] , X₂=h^{x}^{₂} g^{₀} ∈ [symbol] , where g=Ψ(ĝ);
a step of initiating some vectors as follows: \vec{f}=(f, 1,g) ∈ [symbol] ³ and \vec{h}=(1, h, g) ∈ [symbol] ³;
a step of obtaining random polynomials P₁[Z], P₂[Z], P[Z] ∈ [symbol] ₚ [Z] of degree t-1 such that P₁(0)=x₁, P₂(0)=x₂ and P(0)=x₀. For each i ∈ {1, . . . , n}, such step comprises a step of obtaining VKᵢ=(Y_{i,1}, Y_{i,2}) where Y_{i,1}=f^{P}^{₁}⁽ⁱ⁾ g^{P(i)} and Y_{i,2}=h^{P}₂₍ᵢ₎ g^{P(i)};
a step of obtaining random elements in the group [symbol] : \hat{f}_{r,1}, \hat{f}_{r,2} [symbol] [symbol] and defining vectors

$${\vec{f}}_{r , 1} = ( {\hat{f}}_{r , 1} , 1 , \hat{g} ) , {\vec{f}}_{r , 2} = ( 1 , {\hat{f}}_{r , 2} , \hat{g} ) , {\vec{f}}_{r , 3} = {\vec{f}}_{r , 1}^{{φ}_{1}} \cdot {\vec{f}}_{r , 2}^{{φ}_{2}} \cdot {( 1 , 1 , \hat{g} )}^{- 1}$$

where Φ₁, Φ₂ [symbol] [symbol] ₚ. The vectors \vec{f}_{r,1}, \vec{f}_{r,2} and \vec{f}_{r,3} are used as a Groth-Sahai Common reference string (CRS) for the generation of NIZK proofs showing the validity of decryption shares;
a step of obtaining a strongly unforgeable one-time signature Σ=( [symbol] , S, υ) with verification keys consisting of L-bit strings, for some L ∈ poly(λ);
a step of generating a key pair for the one-time linearly homomorphic structure-preserving signature, as the one described in the section entitled “One-time linearly homomorphic structure-preserving signature”, after the description of the FIG. 3, with n=3. Let pkₒₜ=( [symbol] , [symbol] , [symbol] , { [symbol] , [symbol] , [symbol] }ᵢ₌₁³) be the public key, and let skₒₜ={(φᵢ, θᵢ, ω̅ᵢ)}ᵢ₌₁³ be the corresponding private key;
a step of generating a one time homomorphic signatures {(Zⱼ, Rⱼ, Uⱼ)}ⱼ₌₁² on the vectors \vec{f}=(f, 1, g) ∈ [symbol] ³ and \vec{h}=(1, h, g) ∈ [symbol] ³. These consist of:

(Z₁, R₁, U₁)=(f^{-φ}^{₁}g^{-φ}^{₃}, f^{-θ1}g^{-θ}^{₃}, f^{- ω̅}^{₁}g^{- ω̅}^{₃});

(Z₂, R₂, U₂)=(h^{-φ}^{₂}g^{-φ}^{₃}, h^{-γ}^{₂} g^{-θ}^{₃}, h^{- ω̅}^{₁} h^{- ω̅}^{₃});
a step of generating Generate a key pair (pk_{rand}, sk_{rand}) for the randomizable signature described in the section of the description entitled “randomizable linearly homomorphic structure-preserving signature” after the description of the FIG. 3.

Let pk_{rand}=(( [symbol] , [symbol] , [symbol] _{T}), [symbol] , [symbol] , [symbol] , [symbol] , { [symbol] , [symbol] }ᵢ₌₁³,{right arrow over (\hat{f}=(\vec{\hat{f}₁}, \vec{\hat{f}₂}, {\vec{\hat{f}_{3,}}}ᵢ₌₀^{L})) denotes the public key and let sk_{rand}=({χᵢ, γᵢ, δᵢ}ᵢ₌₁³) be the corresponding private key. For simplicity, the generation of (pk_{rand}, sk_{rand}) can re-use the same (g, ĝ) as in the step of obtaining the generators (in the first step);
a step of using the key sk_{rand} to generate one-time linearly homomorphic signatures {(zⱼ, rⱼ, uⱼ)}ⱼ₌₁² on the independent vectors \vec{f}=(f, 1, g) ∈ [symbol] ³ and \vec{h}=(1, h, g) ∈ [symbol] ³. These are obtained as:

(z₁, r₁, u₁)=(f^{-χ}g^{-χ}^{₃}, f^{-γ}^{₁} g^{-γ}^{₃}, f^{-δ}^{₁} g^{-δ}^{₃});

(z₂, r₂, u₂)=(h^{-χ}g^{-χ}^{₃}, h^{-γ}^{₂} g^{-γ}^{₃}, h−δ^{₂} g^{-δ}^{₃});
a step of outputting the public key defined as follows:

PK=(g, \vec{f},\vec{h},\vec{f}_{r,1},\vec{f}_{r,2},\vec{f}_{r,3}, X₁,X₂,pkₒₜ, pk_{rand},{(Zⱼ, Rⱼ,Uⱼ)}_{j=1′}²{(zⱼ, rⱼ, uⱼ)}ⱼ₌₁²)

The evaluation key is SKₕ=Sk_{rand}={χᵢ, γᵢ, δᵢ}ᵢ₌₁³, while the i-th decryption key share is defined to be SK_{d,i}=(P₁(i), P₂(i), P(i)). The vector of verification keys is VK=(VK₁, . . . , VKₙ) where VKᵢ=for i=1 to n.

The function Encrypt'(PK; M), referenced 202, takes in a public key PK and a plaintext M. It outputs a ciphertext C.

In one embodiment, such function 202 comprises:
a step of generating a one-time signature key pair (SVK,SSK)→ [symbol] (λ);
a step of obtaining elements θ₁, θ₂ [symbol] [symbol] ₚ and determining the following elements:

C₀=M·X₁^{θ}^{₁}·X₂^{θ}^{₂},C₁=f^{θ}^{₁},C₂=h^{θ}^{₂},C₃=g^{θ}^{₁}^{+θ}^{₂};
a step of obtaining a derived one time linearly homomorphic signature (Z, R, U) on the vectors (C₁, C₂, C₃) ∈ [symbol] ³. Namely, such derived signature is obtained by computing:

Z=Z₁⁻^{₁}·Z₂^{θ}^{₂} R=R₁^{θ}^{₁}·R₂^{θ}₂ U=U₁^{θ}^{₁}·U₂^{θ}^{₂};
a step of using the signatures {(zⱼ,rⱼ, uⱼ)}ⱼ₌₁² from the public key PK to derive another one time linearly homomorphic signature (z, r, u) on (C₁, C₂, C₃). Namely, using the encryption exponents θ₁, θ₂ ∈ [symbol] ₚ, the following elements are determined:

z=z₁^{θ}^{₁}·z₂^{θ}^{₂} r=r₁^{θ}^{₁}·r₂^{θ}^{₂} u=u₁^{θ}^{₂};
a step of using SVK=(SVK[1], . . . ,SVK[L]) ∈ {0,1}^{L} in order to define the vector \vec{f}_{SVK}=\vec{f}_{3,0}·Πᵢ₌₁^{L}\vec{f}_{3,i}^{SVK[i]} and assemble a Groth Sahai common reference string f_{SVK}=(\vec{f}₁, \vec{f}₂, \vec{f}_{SVK}), where \vec{f}ⱼ=Ψ({right arrow over (\hat{f}ⱼ) for j ∈ {1,2} and \vec{f}_{SVK} is obtained in the same way. Then, using f_{SVK}, generate commitments C_{z}, Cᵣ, Cᵤ to the components of (z, r, u) ∈ [symbol] ³ along with proofs π₁, π₂ as in step 3 of the signing algorithm of the randomizable linearly homomorphic structure preserving signature described in the section of the description entitled “randomizable linearly homomorphic structure-preserving signature” after the description of the FIG. 3). Let (C_{z}, Cᵣ, Cᵤ, π₁, π₂) ∈ [symbol] ¹⁵ be the resulting signature;
a step of generating a one-time signature with the private key SSK applied on the element (C₀, C₁ C₂, C₃, Z, R, U, C_{z}, Cᵣ, Cᵤ, π₁, π₂, σ). The resulting one-time signature is =S(SSK, (C₀, C₁, C₂, C₃, Z, R, U, C_{z}, Cᵣ, Cᵤ, π₁, π₂);
a step of outputting a ciphertext C=(SVK, C₀, C₁, C₂, C₃, Z, R, U, C_{z}, Cᵣ, Cᵤ, π₁, π₂, σ).

The function Ciphertext-Verify'(PK, C), referenced 203, takes as input a public key PK and a ciphertext C. It outputs 1 if C is deemed valid with regards to the public key PK, and 0 otherwise. Such function 203 comprises:
a step of verifying a one-time signature: i.e., determining if V(SVK, (C₀, C₁, C₂, C₃, Z, R, U, C_{z}, Cᵣ, Cᵤ, π₁, π₂), σ)=1;
a step of verifying that both (Z, R, U) ∈ [symbol] ³ and (C_{z}, Cᵣ, Cᵤ, π₁, π₂) ∈ [symbol] ¹⁵ are valid linearly homomorphic signature of (C₁, C₂, C₃). Namely, they should satisfy the relations 1_{G}_{_{T}}=e(Z,Ĝ_{z})·e(R, Ĝᵣ)·Πᵢ₌₁³ e(Cᵢ, Ĝᵢ) and 1_{G}_{_{T}}=e(Z,Ĥ_{z})·e(U, Ĥᵤ)·Πᵢ₌₁³ e(Cᵢ, \vec{H}ᵢ). As well as, if we define \vec{\hat{f}_{SVK}}=\vec{\hat{f}_{3,0}}Πᵢ₌₁^{L}\vec{\hat{f}_{3,l}}^{SVK[i]} the equalities

Πᵢ₌₁³E((1_{G}, 1_{G},Cᵢ),ĝₗ)⁻¹=E(\vec{C}_{z},\hat{g_{z}}).E(\vec{C}ᵣ,\hat{gᵣ}).E(π_{1,1}, {right arrow over (\hat{f}₁).E(π_{1,2},{right arrow over (\hat{f}₂).E(π_{1,3},{right arrow over (\hat{f}_{SVK});

Πᵢ₌₁³E((1_{G},1_{G}, Cᵢ),ĥ\hat{hₗ})⁻¹=E(\vec{C}_{z},\hat{h_{z}}).E(\vec{C}ᵤ,\hat{hᵤ}).E(π_{2,1}, {right arrow over (\hat{f}₁).E(π_{2,2},{right arrow over (\hat{f}₂).E(π_{2,3},{right arrow over (\hat{f}_{SVK}).

If these conditions are satisfied, the function 203 returns 1, otherwise, it returns 0.

The function Share-Decrypt(PK, i, SK_{d,i}, C), referenced 204, takes on input a public key PK, a ciphertext C and a private key share (i, SK_{d,i}), and outputs a special symbol (i, ⊥) if Ciphertext-Verify'(PK, C)=0, otherwise, it outputs a decryption share μᵢ=(i, \hat{μ}ᵢ).

More precisely, in one embodiment, such function 204 takes on input the private key SK _{d,i}=(P₁(i), P₂(i), P(i)) ∈ [symbol] ₚ³ and C, return (i, ⊥) if Ciphertext-Verify'(PK,C)=0. Otherwise, such function 204 comprises a step of determining the decryption share \hat{μ}ᵢ=(νᵢ, \vec{C}_{P}_{₁}, \vec{C}_{P}_{₂}, \vec{C}_{P}, π_{ν}_{ᵢ}) which consists of a partial decryption νᵢ=C₁^{P}^{₁}⁽ⁱ⁾·C₂^{P}^{₂}⁽ⁱ⁾·C₃^{P(i)}, commitments \vec{C}_{P}_{₁}, \vec{C}_{P}_{₂}, \vec{C}_{P} to exponents P₁(i), P₂(i), P(i) ∈ [symbol] ₚ and a proof π_{ν}_{ᵢ} that these relations are satisfied:

νᵢ=C₁^{P}^{₁}⁽ⁱ⁾·C₂^{P}^{₂}⁽ⁱ⁾·C₃^{P(i)}, Y_{i,1}=f^{P}^{₁}⁽ⁱ⁾g^{P(i)}, Y_{i,2}=h^{P}^{₂}⁽ⁱ⁾g^{P(i)}.

The commitments \vec{C}_{P}^{₁}, \vec{C}_{P}^{₂}, \vec{C}_{P} and the proof π_{ν}^{ᵢ} are generated using the Groth-Sahai common reference string (\vec{f}_{r,1}, \vec{f}_{r,2}, \vec{f}_{r,3}).

The function Share-Verify(PK, VKᵢ, C, μᵢ), referenced 205, takes as input the public key PK, the verification key VKᵢ, a ciphertext C and purported decryption share μᵢ=\hat{μ}ᵢ). It outputs either 1 or 0. In the former case, μᵢ is said to be a valid decryption share. We adopt the convention that (i, ⊥) is an invalid decryption share. In one embodiment, the verification key VKᵢ has the following form: Y_{i,2}) ∈ [symbol] ². If \hat{μ}ᵢ=⊥ or if \hat{μ}ᵢ cannot be parsed properly as (νᵢ, \vec{C}_{P}^{₁}, \vec{C}_{P}₂, \vec{C}_{P}, π_{μ}_{ᵢ}), 0 is returned. Otherwise, if π_{ν}_{ᵢ} is a valid proof, 1 is returned.

The function Combine(PK, VK, C, {μᵢ}_{i∈s}), referenced 206, takes as input the elements PK, VK, C and a t-subset S ⊂ {1, . . . , n} with decryption shares {μᵢ}_{i∈s}, and outputs either a plaintext M or ⊥ if the set contains invalid decryption shares. Such function 206 comprises a step of parsing the decryption share \hat{μ}ᵢ as (νᵢ, \vec{C}_{P}_{₁}, \vec{C}_{P}_{₂}, \vec{C}_{P}, π_{μ}_{ᵢ}) for each i ⊂ S, such step returns ⊥ if Share-Verify(PK, VK, C, (i, \hat{μ}ᵢ))=0. If Share-Verify(PK, VK, C, (i, \hat{μ}ᵢ))=1 for each i ∈ S the function comprises a further step of determining (by Lagrange interpolation) the following value:

$$v = {\prod }_{i ∈ S} {v}_{i}^{{Δ}_{i , s} ( 0 )} = {C}_{1}^{{x}_{1}} \cdot {C}_{2}^{{x}_{2}} \cdot {C}_{3}^{y} = {X}_{1}^{{θ}_{1}} \cdot {X}_{2}^{{θ}_{2}}$$

which allows recovering M=C₀ν.

At last, the function Eval'(PK, SKₕ, C⁽¹⁾, C⁽²⁾), referenced 207, is an homomorphic evaluation algorithm. It takes as input the evaluation key SKₕ and two distinct ciphertexts C⁽¹⁾ and C⁽²⁾. If there exists j ∈ {1,2} such that Ciphertext-Verify'(PK, C^{(j)})=0, the algorithm returns ⊥. Otherwise, it conducts a binary homomorphic operation over C⁽¹⁾ and C⁽²⁾ and outputs a ciphertext C.

More precisely, in one embodiment of the invention, such function 207 comprises:
a step of parsing SKₕ as {χᵢ, γᵢ, δᵢ}ᵢ₌₁³ and for each j ∈ {1,2}, parsing C^{(j)} as:

C^{(j)}=(SVK^{j}, C₀^{(j)}, C₁^{(j)}, C₂^{(j)}, C₃^{(j)}, Z^{(j)}, R^{(j)}, U^{(j)}, C_{z}^{(j)}, Cᵣ^{(j)}, Cᵤ^{(j)}^{(j)}, π₁^{(j)}, π₂^{(j)}, σ^{(j)});
a step of determining the elements C₀=Πⱼ₌₁² C₀^{(j)}, C₁=Πⱼ₌₁² C₁^{(j)}, C₂=Πⱼ₌₁² C₂^{(j)} and C₃=Πⱼ₌₁² c₃^{(j)} as well as Z=C₀=Πⱼ₌₁²Z^{(j)}, R=Πⱼ₌₁²R^{(j)} and U=Πⱼ₌₁²U^{(j)};
a step of generating a new one-time signature key pair (SVK,SSK)← [symbol] (λ);
a step of using the private evaluation key SKₕ={χᵢ, γᵢ, δᵢ}ᵢ₌₁³ in order to generate a linearly homomorphic signature on \vec{C}_{z}, \vec{C}ᵣ, \vec{C}ᵤ, \vec{π₁}, \vec{π₂} on the vector (C₁, C₂, C₃) using a randomizable linearly homomorphic structure-preserving signature (as the one described in the section of the description after the description of the FIG. 3) for the file identifier SVK;
a step of outputting the derived ciphertext (SVK, C₀, C₁, C₂, C₃, Z, R, U, \vec{C}_{z}, \vec{C}ᵣ, \vec{C}ᵤ, \vec{π₁}, \vec{π₂}σ) where σ=S (SSK, (C₀, C₁, C₂, C₃, Z, R, U, \vec{C}_{z}, \vec{C}ᵣ, \vec{C}ᵤ, \vec{π₁}, \vec{π₂})).

If such scheme is instantiated using Groth's discrete-logarithm-based one-time signature as described in the article “Simulation-sound NIZK proofs for a practical language and constant size group signatures” by Groth and published in the proceedings of the conference Asiacrypt 2006, the ciphertext consists of 26 elements of [symbol] and one element of [symbol] ₚ. It can be proven that the KH-CCA security of the scheme assuming that Σ is a strongly unforgeable one-time signature and that the DLIN assumption (i.e. the Decision Linear Problem assumption) holds in [symbol] and [symbol] . The security proof stands in the standard model and does not rely on random oracles.

Let's remark that the above syntax generalizes that of ordinary threshold cryptosystems. By setting SKₕ=E and discarding the evaluation algorithm, we obtain the definition of a threshold encryption system.

The threshold keyed-homomorphic public-key cryptosystem disclosed in FIG. 2 is secure against chosen ciphertext attacks (or KH-CCA secure). Indeed, no PPT adversary has noticeable advantage in this game:
1. The challenger runs Keygen(λ; t; n) to obtain a public key PK, a vector of decryption key shares SK_{d}=(SK_{d,1}, . . . , SK_{d,n}) and a, homomorphic evaluation key SKₕ. It gives PK and keeps (SKₕ; SK_{d}) to itself. In addition, the challenge initializes a set D as an empty set;
2. The adversary A adaptively makes queries to the following oracles on a polynomial number of occasions:
   Corruption query: at any time, the adversary A may decide to corrupt a server. To this end, it specifies an index i ∈ {1, . . . , n} and obtains the private key share
   Evaluation query: at any time, the adversary A can invoke the evaluation oracle Evalλ(SKₕ,.) on a pair (C⁽¹⁾, C⁽²⁾) of ciphertexts of its choice. If there exists j ∈ {1,2} such that Ciphertext-Verify'(PK, C₍ⱼ₎)=0, the algorithm returns ⊥. Otherwise, the oracle Eval(SKₕ,.) computes C←Eval(SKₕ, C⁽¹⁾, C⁽²⁾) and returns C. In addition, if C⁽¹⁾) ∈ D or C⁽²⁾ ∈ D, it sets D←D ∪ U {C}.
   Reveal query: at any time, the adversary A may also decide to corrupt the evaluator by invoking the RevHK oracle on a unique occasion. The oracle responds by returning SKₕ.
   Decryption query: the adversary A can also invoke the partial decryption oracle on arbitrary ciphertexts C and indexes i E ∈ {1, . . . , n}. If Ciphertext-Verify'(PK, C)=0, or if C ∈ D , the oracle returns ⊥. Otherwise, the oracle returns the decryption share μᵢ←Share-Decrypt(PK, i, SK_{d,i}, C);
3. The adversary A chooses two equal-length messages M₀, M₁ and obtains a ciphertext C*=Encrypt'(PK, M_{β}) for some random bit β [symbol] {0,1}. In addition, the challenger sets D←D ∪ U {C*};
4. The adversary A makes further queries as in step 2 with some restrictions. Namely, the adversary A cannot corrupt more than t-1 servers throughout the entire game. Moreover, if the adversary A chooses to obtain SKₕ(via the RevHK oracle) at some point, no more decryption query is allowed beyond that point;
5. The adversary A outputs a bit β′ and is deemed successful if β′=β. As usual, adversary A's advantage is measured as the distance

$$Adv ( A ) = \vert Pr ( {β}^{′} = β ) - \frac{1}{2} \vert .$$

Again, if we set SKₕ=∈ and remove the Eval and RevHK oracles, we obtain a definition of chosen-ciphertext security for classical threshold cryptosystems. It is important to note that, even if the adversary A chooses to obtain SKₕ immediately after having seen the public key PK it still has access to the decryption oracle before the challenge phase. In other words, the scheme should remain IND-CCA1 (i.e. secure against non-adaptive chosen ciphertext attacks, where the adversary has no access to decryption oracles beyond the challenge phase) if the adversary A is given PK and SKₕ at the outset of the game.

The schemes depicted in the FIGS. 1 and 2 prevent an adversary to obtain information by invoking the decryption oracle on invalid ciphertexts either before or after post challenge decryption queries.

Such schemes rely on the three following features:
(a) The use of a derived signature (z, r, u) on the vectors (C₁, C₂, C₃) ∈ [symbol] ³ obtained from the execution of the function 102 and comprised in the ciphertext (in the first embodiment), and of a derived signature (Z, R, U) on the vectors (C₁, C₂, C₃) ∈ [symbol] ³ obtained from the execution of the function 202 and comprised in the ciphertext (in the first embodiment). Such derived signature serves as publicly verifiable evidence that elements (f, g, h, C₁, C₂, C₃) has the right form; The second derived signature (Z, R, U) can be seen as a homomorphic proof that (C₁, C₂, C₃) ∈ [symbol] ³ are well-formed and it allows retaining CCA1 security when the evaluation key is compromised
(b) The use of a simulation-sound proof that (C₁, C₂, C₃) ∈ G³ is well-formed.

This proof (C_{z},Cᵣ, Cᵤ, π₁, π₂) ∈ [symbol] ¹⁵ consists of commitments to group elements (z, r, u) that are obtained as functions of private random values θ₁, θ₂ , and proofs associated to these commitments. This simulation-sound proof can be viewed as an additional homomorphic signature comprised in the ciphertext. In the first embodiment, this simulation-sound proof is obtained as a set of elements σ₁, \vec{C}_{σ}_{₀}, \vec{C}_{Θ}_{₁}, \vec{C}_{Θ}_{₂} and π_{OR}. In the second embodiment, it corresponds to the determination of another derived signature on the vectors (C₁, C₂, C₃) ∈ [symbol] ³, i.e. the signature (z, r, u), the generation of commitments C_{z}, Cᵣ, Cᵤ to the components of (z, r, u) ∈ [symbol] ³ along with proofs π₁,π₂. In such embodiment, additional signature corresponds to (C_{z}, Cᵣ, Cᵤ,π₁,π₂) ∈ [symbol] ¹⁵;
(c) The generation and the use of a one time key pair (the pair (SVK , SSK) in the first embodiment and in the second embodiment) in order to sign the concatenation of the elements (C₀C₁, C₂, C₃) with the derived signature mentioned at point (a) and the additional signature mentioned at point (b). The ciphertext then comprises the signature obtained at point (c), the verification key SVK and the signed elements (i.e. the previously mentioned concatenation).

Let's remark that the new simulation-sound non-interactive proof based on homomorphic signatures can be used in other constructions. In the second embodiment, it was used in combination with the Cramer-Shoup encryption paradigm. Alternatively, it can be used in the Naor-Yung encryption paradigm (described in the article “Public-key Cryptosystems Provably Secure against Chosen Ciphertext Attacks”by M. Naor et al., published in the proceedings of the conference STOC 1990,) and its refinement suggested by Sahai described in the article “Non-Malleable Non-Interactive Zero Knowledge and Adaptive Chosen-Ciphertext Security”, published in the proceedings of the conference FOCS 1999). In its basic form, the Naor-Yung technique consists in encrypting the same message under two distinct public keys and appending a non-interactive proof of plaintext equality. Sahai showed that, if the underlying proof system is simulation-sound, the resulting cryptosystem is secure against adaptive chosen-ciphertext attacks (IND-CCA2). The new unbounded simulation-sound proof system can be used for this purpose because, in the El-gamal and Boneh-Boyen-Shacham encryption schemes, the equality of two encrypted plaintexts can be expressed in termed of membership (of a vector of group elements obtained by dividing the two ciphertexts) in a linear subspace. The described embodiments in the present document rather uses the Cramer-Shoup paradigm because it yields shorter ciphertexts and, in the threshold setting, it makes it easier to prove security against adaptive corruptions (as pointed out in the article “Non-Interactive CCA2-Secure Threshold Cryptosystems with Adaptive Security: New Framework and Constructions” by B. Libert, published in the proceedings of the conference, TCC 2012). However, one skilled in the art could adapt the presented embodiments from the teachings of the present document.

FIG. 3 presents a device that can be used to perform one or several steps of methods disclosed in the present document.

Such device referenced 300 comprises a computing unit (for example a CPU, for “Central Processing Unit”), referenced 301, and one or several memory units (for example a RAM (for “Random Access Memory”) block in which intermediate results can be stored temporarily during the execution of instructions a computer program, or a ROM block in which, among other things, computer programs are stored, or an EEPROM (“Electrically-Erasable Programmable Read-Only Memory”) block, or a flash block) referenced 302. Computer programs are made of instructions that can be executed by the computing unit. Such device 300 can also comprise a dedicated unit, referenced 303, constituting an input-output interface to allow the device 300 to communicate with other devices. In particular, this dedicated unit 303 can be connected with an antenna (in order to perform communication without contacts), or with serial ports (to carry communications “contact”). Let's remark that the arrows in FIG. 3 means that the linked units can exchange data through buses for example together.

In an alternative embodiment, some or all of the steps of the method previously described, can be implemented in hardware in a programmable FPGA (“Field Programmable Gate Array”) component or ASIC (“Application-Specific Integrated Circuit”) component.

In an alternative embodiment, some or all of the steps of the method previously described, can be executed on an electronic device comprising memory units and processing units as the one disclosed in the FIG. 3.

A One-Time Linearly Homomorphic Structure-Preserving Signatures

A one-time linearly homomorphic signature scheme is a scheme where messages and signatures only consist of group elements (here, “one time” means that only one linear subspace can be signed using a private key). The security of such scheme can be proven under an assumption which is implied by the DLIN assumption.

A one-time linearly homomorphic structure-preserving signature scheme is defined by a set of algorithms functions defined as follows:

Keygen(λ, n): given a security parameter λ, and the dimension n ∈ [symbol] of the subspace to be signed, choose bilinear group ( [symbol] , [symbol] , [symbol] _{T}) of prime order p>2^{λ}. Then, conduct the following steps.

1. Choose [symbol] , [symbol] , [symbol] ,

[symbol]

[symbol]

[symbol]

2. For i=1 to n, pick χᵢ, γᵢ, δᵢ [symbol] [symbol] ₚ* and compute group elements ĝₗ= [symbol] ^{χi}· [symbol] ^{γi} and ĥₗ= [symbol] ^{χi}· [symbol] ^{γi};

The private key is sk=({χᵢ,γᵢ, δᵢ}ᵢ₌₁ⁿ) while the public key consists of pk=( [symbol] , [symbol] , [symbol] ,{ĝₗ, [symbol] }ᵢ₌₁ⁿ).

Sign(sk, τ, (M₁, . . . , Mₙ): to sign a vector (M₁, . . . , Mₙ) ∈ [symbol] ⁿ with regards to the file identifier τ using sk=({χᵢ, γᵢ, δᵢ}ᵢ₌₁ⁿ), compute and output σ=(z, r, u) ∈ [symbol] ³ where

z=Πᵢ₌^{l}Mᵢ^{-χ}^{ᵢ}, r=Πᵢ₌₁^{l}Mᵢ^{-γ}^{ᵢ} and u=Πᵢ₌₁^{l}Mᵢ^{-δi}.

SignDerive (pk, τ, ({ωᵢ, σᵢ}ᵢ₌₁^{l})): given pk, an identifier τ and l uplet (ωᵢ, σᵢ), parse σᵢ as σᵢ=(zᵢ, rᵢ, uᵢ)) ∈ [symbol] ³ for i=1 to l. Then, compute and return=(z, r, u) ∈ [symbol] ³, where z=Πᵢ₌₁ₗ zᵢ^{ω}^{ᵢ}, r= 529 ᵢ₌₁^{l} rᵢ^{ω}^{ᵢ} r=and u=Πᵢ₌₁^{l} uᵢ^{ω}^{ᵢ}.

Verify(pk, σ, τ, (M₁, . . . , Mₙ): given a signature σ=(z, r, u) ∈ [symbol] ³, a file identifier τ and a vector (M₁, . . . , Mₙ), return 1 if and only if (M₁, . . . , Mₙ)≠(1 [symbol] , . . . , 1 [symbol] ) and (z, r, u) satisfy

1 [symbol] _{_{T}}=e(z, [symbol] ).e(r, [symbol] ).Πᵢ₌₁ⁿe(Mᵢ,\vec{g}ₗ) and

1 [symbol] _{_{T}}=e(z, [symbol] ).e(r, [symbol] ).Πᵢ₌₁ⁿe(Mᵢ, [symbol] ).

A Randomizable Linearly Homomorphic Structure Preserving Signature

This section describes a randomizable linearly homomorphic structure-preserving signature scheme. Compared to the known original scheme, there is one slight modification: while the original scheme uses symmetric pairings, the description below allows for asymmetric pairing configurations ( [symbol] , [symbol] , [symbol] _{T}) of Type II. Namely, we assume the availability of an efficiently computable isomorphism Ψ: [symbol] → [symbol] . The reason is that the security proof would require a less standard assumption than SXDLIN in Type III configurations. In this construction, each signature basically consists of a NIWI proof of knowledge of a one-time signature. This proof of knowledge is generated on a Groth-Sahai CRS (\vec{f}₁, \vec{f}₂ , \vec{f}_{τ}) that depends on the tag τ that identifies the dataset which is being signed. In the following, for any vectors \vec{f}=\hat{f}₁, \vec{f}₂, \vec{f}₃) and \vec{g}=g₂, g₃), we define the notations E (g, \vec{f})=(e(g, \hat{f}₁), e(g, \vec{f}₂), e(g, \hat{f}₃)) and E(\vec{g}, f)=(e(g₁, f), e(g₂, f), e(g₃, f)).

Keygen(λ, n): given a security parameter λ and the dimension n ∈ N of the subspace to be signed, choose bilinear group ( [symbol] , [symbol] , [symbol] _{T}) of prime order p>^{λ} with an efficient isomorphism Ψ: [symbol] → [symbol] . Then, conduct the following steps:
Choose generators ĝ [symbol] [symbol] and determine g=Ψ(ĝ);
Choose ĥᵤ [symbol] [symbol] , α_{z}, αᵣ, β_{z} [symbol] [symbol] ₚ* and define ĝ_{z}=ĥᵤ^{α}^{_{z}}, ĝᵣ=ĥᵤ^{α}^{ᵣ}, ĥᵣ, \vec{h}_{z}=ĥᵤ^{βz}
For i=1 to n, pick random χᵢ, γᵢ, δᵢ ^{R}→ [symbol] ₚn* and compute group elements ĝᵢ=ĝ_{z} ^{χ}^{ᵢ}.ĝᵣ^{γ}^{ᵢ}, ĥᵢ=ĥ_{z}^{χ}^{ᵢ}.ĥᵤ^{δ}^{ᵢ}.
Generate L+1 Groth Sahai common reference strings. To this end, choose \hat{f}₁, \hat{f}₂ [symbol] [symbol] and define vectors \vec{\hat{f}₁}=(\hat{f}₁, 1, ĝ) ∈ [symbol] ³, \vec{\hat{f}₂}=(1, \hat{f}₂, ĝ) ∈ [symbol] ³.
Then, pick {right arrow over (\hat{f}_{3,i} [symbol] [symbol] ³ i=0 to L.

The public key consists of PK=(( [symbol] , [symbol] , [symbol] _{T}), ĝ_{z}, ĝᵣ, ĥ_{z}, ĥᵤ, {ĝᵢĥᵢ,}ᵢ₌₁ⁿ, {right arrow over (\hat{f}=(\vec{\hat{f}₁}, \vec{\hat{f}₂}, {{right arrow over (\hat{f}_{3,i}}ᵢ₌₀ ^{L})), while the private key is sk=(Ψ(ĥ_{z})^{α}^{ᵣ}, {χᵢ, γᵢ, δᵢ}ᵢ₌₁ⁿ). Sign(sk, τ, (M₁, . . . , Mₙ): to sign a vector (M₁, . . . , Mₙ) ∈ [symbol] ⁿ with the file identifier τ using sk=(Ψ(ĥ_{z})^{α}^{ᵣ}, {χᵢ, γᵢ, δᵢ}ᵢ₌₁ⁿ), conduct the following steps:
1. Choose θ [symbol] [symbol] ₚ and determine the following elements z, r and u as follows:

z=Ψ(ĝᵣ)^{θ}Πᵢ₌₁^{l}Mᵢ^{-χ}^{ᵢ},r=Ψ(ĝ_{z})^{-θ}Πᵢ₌₁^{l}Mᵢ^{-γ}^{ᵢ} and u=Ψ(ĥ_{z})^{-θα}^{ᵣ}Πᵢ₌₁^{l}Mᵢ^{-δ}^{ᵢ}.
2. Using the bits of the file identifier τ=(τ[1], . . . , τ[L]) ∈ {0,1}^{L}, define the vector \vec{f}_{τ}=\vec{f}_{3,0}.Πᵢ₌₁^{L}\vec{f}_{3,i}^{τ[i]} and assemble a Groth Sahai common reference string f_{τ}=(\vec{f}₁, \vec{f}₂, \vec{f}_{τ}), where \vec{f}ⱼ=Ψ({right arrow over (\hat{f}ⱼ) for j ∈ {1,2} and \vec{f}_{3,k}=Ψ({right arrow over (\hat{f}_{3,i}) for k ∈ {0, . . . , L}.
3. Then, using f_{τ}, generate Groth Sahai commitments \vec{C}_{z}, \vec{C}ᵣ, \vec{C}ᵤ to the components of (z, r, u) ∈ [symbol] ³ along with proofs π₁, π₂ as follows: \vec{C}_{z}=(1 [symbol] , 1 [symbol] , z).\vec{f}₁^{ν}^{_{z,1}}\vec{f}₂^{ν}^{_{z,2}}. \vec{f}₃^{ν}^{_{z,3}}, \vec{C}ᵣ=( [symbol] , [symbol] , r).\vec{f}₁^{ν}^{_{r,1}}\vec{f}₂^{ν}^{_{r,3}} and Ĉᵤ=( [symbol] , [symbol] , u).\vec{f}₁^{ν}^{_{u,1}}\vec{f}₂^{ν}^{_{u,2}}.\vec{f}₃^{ν}^{_{u,3}}. Then generate a NIWI proofs \vec{π}₁=(π_{1,1}, π_{1,2}, π_{1,3}) ∈ [symbol] ³ and \vec{π}₂=(π_{2,1}, π_{2,2}, π_{2,3}) ∈ [symbol] ³ that (z, r, u) satisfy the equations 1 [symbol] _{_{T}}=e(z, ĝ_{z}).e(r,ĝᵣ).√ᵢ₌₁ⁿe(Mᵢ, ĝᵢ) and 1_{G}_{_{T}}=e(z, ĥ_{z}).e(u, ĥᵤ). Πᵢ₌₁ⁿe(Mᵢ,ĥᵢ).

These proofs are obtained as

\vec{π}₁=(Ψ(ĝ_{z})^{-ν}^{_{z,1}}.Ψ(ĝᵣ)^{-ν}_{r,1}, Ψ(ĝ_{z})^{-ν}^{_{z,2}}.Ψ(ĝᵣ)^{-ν}^{_{r,2}},Ψ(ĝ_{z})^{-ν}^{_{z,3}}.Ψ(ĝᵣ)^{-ν}^{_{r,3}});

\vec{π}₂=(Ψ(ĥ_{z})^{-ν}^{_{z,1}}.Ψ(ĥᵤ)^{-ν}^{_{u,1}}, Ψ(ĥ_{z})^{-ν}^{_{z,2}}.Ψ(ĥᵤ)^{-ν}_{u,2},Ψ(ĥ_{z})^{-ν}^{_{z,3}}.Ψ(ĥᵤ)^{-ν}^{_{u,3}});

and satisfy the verification equations

Πᵢ₌₁ⁿE(( [symbol] , [symbol] , Mᵢ),ĝᵢ)⁻¹=E(\vec{C}_{z},ĝ_{z}).E(\vec{C}ᵣ, \vec{g}ᵣ).E(π_{1,1},{right arrow over (\hat{f}₁).E(π_{1,2},{right arrow over (\hat{f}₂).E(π_{1,3},{right arrow over (\hat{f}_{τ})

and

Πᵢ₌₁ⁿE(( [symbol] , [symbol] ,Mᵢ),ĥᵢ)⁻¹=E(\vec{C}_{z},ĥ_{z}).E(\vec{C}ᵤ,ĥᵤ).E(π_{2,1},\vec{\hat{f}₁}).E(π_{2,2},\vec{\hat{f}₂}).E(π_{2,3},\vec{\hat{f}_{τ}})

The signature consists of σ=(\vec{C}_{z}, \vec{C}ᵣ, \vec{C}ᵤ, \vec{π}₁ , \vec{π}₂) ∈ [symbol] ¹⁵ . SignDerive (pk, τ, ({ωᵢ,σᵢ}ᵢ₌₁^{l})): given pk, an identifier τ and l uplet (ωᵢ, σᵢ), parse σᵢ as σᵢ=(\vec{C}_{z,i}, \vec{C}_{r,i}, \vec{C}_{u,i}, \vec{π}_{1,i}, \vec{π}_{2,i})) ∈ [symbol] ¹⁵ for i =1 to l. Then, compute the elements

\vec{C}_{z}=Πᵢ₌₁^{l}\vec{C}_{z,i}^{ω}^{ᵢ}, \vec{C}ᵣ=Πᵢ₌₁^{l}\vec{C}_{r,i}^{ω}^{ᵢ}, \vec{C}ᵤ=Πᵢ₌₁^{l}\vec{C}_{u,i}^{ω}^{ᵢ}, \vec{π}₁=Π=1^{l}\vec{π}_{1,i}^{ω}^{ᵢ} and, \vec{π}₂=Πᵢ₌₁^{l}\vec{π}_{2,i}^{ω}^{ᵢ}.

Then, re-randomize the above commitments and proofs and return the re-randomized values of σ=(\vec{C}_{z}, \vec{C}ᵣ, \vec{C}ᵤ, \vec{π}₁, \vec{π}₂).

Verify(pk, σ, τ, (M₁, . . . , Mₙ)): given a purported signature σ=(z, r, u) ∈ [symbol] ³, a file identifier and a message (M₁, . . . , Mₙ), parse σ as (\vec{C}_{z}, \vec{C}ᵣ, \vec{C}ᵤ, \vec{π}₁, \vec{π}₂). Return 1 if and only if (M₁, . . . , ≠( [symbol] , . . . , [symbol] ) and (z, r, u) satisfy the equations

Πᵢ₌₁ⁿE(( [symbol] , [symbol] ,Mᵢ),ĝᵢ)⁻¹=E(\vec{C}_{z},ĝ_{z}).E(\vec{C}ᵣ,ĝᵣ).E(π_{1,1},\vec{\hat{f}₁}).E(π_{1,2},\vec{\hat{f}₂}).E(π_{1,3},\vec{\hat{f}_{τ}}) and

Πᵢ₌₁ⁿE(( [symbol] , [symbol] ,Mᵢ),ĥᵢ)⁻¹E(\vec{C}_{z},\vec{h}_{z}).E(\vec{C}_{z}).E(\vec{C}ᵤ,ĥᵤ).E(π_{2,1},\vec{\hat{f}₁}).E(π_{2,2},\vec{\hat{f}₂}).E(π_{2,3},\vec{\hat{f}_{τ}}).

We remark that the above scheme can be simplified by setting 0=0, in the signing algorithm: since all non-interactive proofs are generated for a perfectly NIWI Groth-Sahai CRS, this modification does not affect the distribution of signatures. In this case, the private key component Ψ(ĥ_{z})^{α}^{ᵣ} is no longer necessary. Such simplification is used in the second embodiment of the invention.

1. Method for ciphering a message by a sender device at destination to a receiver device, said method comprising using a keyed homomorphic encryption function associated with a public key of said receiver device, wherein it comprises:
ciphering said message with an encryption scheme secure against adaptive chosen-ciphertext attacks, in function of a first element of said public key, delivering a ciphertext;
determining for said ciphertext, an homomorphic non-interactive proof and a simulation-sound non-interactive proof, said homomorphic non-interactive proof being obtained in function of a set of signatures comprised in said public key, and said simulation-sound non-interactive proof being obtained in function of a second element comprised in said public key, and an evaluation key of said keyed homomorphic encryption function being an element linked to said second element;
delivering a cipher of said message comprising said ciphertext, said homomorphic non-interactive proof and said simulation-sound non-interactive proof.

2. Method for ciphering according to claim 1, wherein said cipher of said message further comprises a one-time verification public key SVK and a one-time signature corresponding to a signature of a concatenation of said ciphertext, said homomorphic non-interactive proof and said simulation-sound non-interactive proof, said signature being verifiable with said verification public key SVK.

3. Method for ciphering according to claim 1, wherein said encryption scheme is based on the Naor-Yung encryption paradigm.

4. Method for ciphering according to claim 1, wherein said encryption scheme is based on the Cramer-Shoup paradigm.

5. Method for ciphering according to claim 4, wherein said ciphertext corresponds to an uplet
(C₀, C₁, C₂, C₃)=(M·X₁^{θ}^{₂}·X₂^{θ}^{₂}, f^{θ}^{₂}, h^{θ}^{₂},g^{θ}^{₂}⁺⁶_{₂}) where M is said message and belongs to a group G, encryption exponents θ₁, θ₂ that belong to group Zₚ are private random values, and elements X₁=f^{x}^{₂}g^{x}^{₀} ∈ [symbol] and X₂=h^{x}^{₂}g^{x}^{₀}∈ [symbol] are comprised in said public key, with (x₀, x₁, x₂) ∈ [symbol] ₚ³ being unknown elements for said sender device and corresponding to a private key for said receiver device, and elements g, f, h are elements that belong to said group G.

6. Method for ciphering according to claim 5, wherein determining said homomorphic non-interactive proof comprises:
obtaining said set of signatures which is a signature on independent vectors \vec{f}=(f, 1, g) ∈ [symbol] ³ and \vec{h}=∈ [symbol] ³ comprising elements {(aⱼ, b, cⱼ)}ⱼ₌₁² obtained through a use of a private key sk′={χᵢ, γᵢ, δᵢ}ᵢ₌₁³, with (χᵢ, γᵢ, δᵢ) ∈ [symbol] ₚ³, and (a₁, b₁, c₁)=(f^{-χ}^{₂}g^{-χ}^{₃}, f^{-γ}^{ᵢ}g^{-γ}^{₂}, f^{-δ}^{₁}g^{-δ}^{₃}), (a₂, b₂, c₂)=(h^{-χ}^{₂}g^{-χ}^{₃}, h^{-γ}^{₂}g^{-γ}^{₂}, h^{-δ}^{₂}g^{-δ}^{₃}), and public key associated to said private key sk′ being comprised in said public key of said receiver device;
deriving a linearly homomorphic signature from said set of signatures and said encryption exponents θ₁, θ₂, delivering a derived signature (a, b, c)=(a₁^{θ}^{₂}·a₂^{θ}^{₂}, b=b₁^{θ}^{₁}·b₂^{θ}^{₂}, c=c₁^{θ}^{₁}·c₂^{θ}^{₂}) on the vector (C₁, C₂, C₃), said derived signature being said homomorphic non-interactive proof.

7. Method for ciphering according to claim 2, wherein determining said simulation-sound non-interactive proof comprises:
obtaining said second element corresponding to a one time homomorphic signature on the independent vectors \vec{f}=(f, 1, g) ∈ [symbol] ³ and \vec{h}=(1, h, g) ∈ [symbol] ³ generated with a private key, said evaluation key corresponding to said private key;
determining a derived signature on said second element, said derived signature being a one-time linearly homomorphic signature;
generating commitments on said derived signature using a Groth-Sahai common reference string based on said one-time verification public key VK;
generating proofs with a randomizable linearly homomorphic structure-preserving signing method, said simulation-sound non-interactive proof being a concatenation of said commitments and said proofs.

8. Method for ciphering according to claim 4, wherein determining said simulation-sound non-interactive proof comprises determining a non-interactive witness OR proof in function of said encryption exponents θ₁, θ₂ and said second element, said second element being a verification key of a digital signature method, and said evaluation key being a corresponding private key of said verification key of said digital signature method.

9. Method for ciphering according to claim 8, wherein said digital signature method is a Waters signature method.

10. Method for processing a cipher of a message, said method being executed by a receiver device, and said method being characterized in that it comprises:
obtaining a homomorphic non-interactive proof and a simulation-sound non-interactive proof that are associated to said cipher;
verifying a validity of said homomorphic non-interactive proof and said simulation-sound non-interactive proof, delivering an information of validity of said cipher.

11. Method according to claim 10, wherein said method further comprises obtaining said message from said cipher in case that said information of validity asserts that said cipher is valid, by using a private key.

12. Method according to claim 10, wherein when at least a first and a second cipher of a first message and a second message are obtained by said receiver device, the method further comprises a set of combining said first and said second cipher by using an evaluation key, delivering a third cipher comprising an homomorphic non-interactive proof and a simulation-sound non-interactive proof.

13. A computer-readable and non-transient storage medium storing a computer program comprising a set of computer-executable instructions to implement a method for cryptographic computations when the instructions are executed by a computer, wherein the instructions comprise instructions, which when executed, configure the computer to perform a method for ciphering a message, said method comprising using a keyed homomorphic encryption function associated with a public key of a receiver device, wherein it comprises:
ciphering said message with an encryption scheme secure against adaptive chosen-ciphertext attacks, in function of a first element of said public key, delivering a ciphertext;
determining for said ciphertext, an homomorphic non-interactive proof and a simulation-sound non-interactive proof, said homomorphic non-interactive proof being obtained in function of a set of signatures comprised in said public key, and said simulation-sound non-interactive proof being obtained in function of a second element comprised in said public key, and an evaluation key of said keyed homomorphic encryption function being an element linked to said second element;
delivering a cipher of said message comprising said ciphertext, said homomorphic non-interactive proof and said simulation-sound non-interactive proof.

14. A computer-readable and non-transient storage medium storing a computer program comprising a set of computer-executable instructions to implement a method for cryptographic computations when the instructions are executed by a computer, wherein the instructions comprise instructions, which when executed, configure the computer to perform a method for processing a cipher of a message, wherein said method comprises:
obtaining a homomorphic non-interactive proof and a simulation-sound non-interactive proof that are associated to said cipher;
verifying a validity of said homomorphic non-interactive proof and said simulation-sound non-interactive proof, delivering an information of validity of said cipher.

15. Electronic device comprising a ciphering module configured to cipher a message, said ciphering module comprising a module configured to use a keyed homomorphic encryption function associated with a public key of a receiver device, wherein said module configured to use comprises:
a module configured to cipher said message with an encryption scheme secure against adaptive chosen-ciphertext attacks, in function of a first element of said public key, delivering a ciphertext;
a module configured to determine for said ciphertext, an homomorphic non-interactive proof and a simulation-sound non-interactive proof, said homomorphic non-interactive proof being obtained in function of a set of signatures comprised in said public key, and said simulation-sound non-interactive proof being obtained in function of a second element comprised in said public key, and an evaluation key of said keyed homomorphic encryption function being an element linked to said second element;
a module configured to deliver a cipher of said message comprising said ciphertext, said homomorphic non-interactive proof and said simulation-sound non-interactive proof.

16. Electronic device comprising a module configured to process a cipher of a message, wherein said module comprises:
a module configured to obtain a homomorphic non-interactive proof and a simulation-sound non-interactive proof that are associated to said cipher;
a module configured to verify a validity of said homomorphic non-interactive proof and said simulation-sound non-interactive proof, delivering an information of validity of said cipher.
